(19) United States
(12) Patent Application Publication
(10) Pub. No.: US 2024/0421312 A1
(43) Pub. Date: Dec. 19, 2024

(54) POWDER FOR ELECTRODE, MANUFACTURING METHOD THEREOF, ELECTRODE FOR SECONDARY BATTERY INCLUDING THE SAME, AND MANUFACTURING METHOD THEREOF

(71) Applicants: Hyundai Motor Company, Seoul (KR); Kia Corporation, Seoul (KR)

(72) Inventors: Ju Young Jang, Goyang (KR); Byung Yong Lee, Anyang (KR)

(21) Appl. No.: 18/537,104

(22) Filed: Dec. 12, 2023

(30) Foreign Application Priority Data
Jun. 16, 2023 (KR) 10-2023-0077264

(51) Int. Cl. H01M 4/62; B01F 23/60; B01F 23/80; G01N 19/00; H01M 4/131; H01M 4/1391; H01M 4/505; H01M 4/525; H01M 10/0525; H01M 10/0562

(52) U.S. Cl. CPC H01M 4/623; B01F 23/60; B01F 23/81; G01N 19/00; H01M 4/131; H01M 4/1391; H01M 4/505; H01M 4/525; H01M 4/625; H01M 10/0525; H01M 10/0562; B01F 2215/0472; B01F 2215/0477; B01F 2215/0481; H01M 2004/021; H01M 2300/008

(57) ABSTRACT

The present disclosure can implement a high energy density electrode by quantifying and standardizing a degree of fiberization of powder for an electrode used in a dry electrode. The powder includes an active material; a solid electrolyte; a conductive material; and a fibrous binder.

### CROSS-REFERENCE TO RELATED APPLICATION

This application claims under 35 U.S.C. § 119 (a) the benefit of Korean Patent Application No. 10-2023-0077264 filed on Jun. 16, 2023, the entire contents of which are incorporated herein by reference.

### BACKGROUND

### (a) Technical Field

The present disclosure relates to a powder for an electrode, a manufacturing method thereof, an electrode for a secondary battery including the same, and a manufacturing method thereof.

### (b) Background

Recently, for developing high energy density battery specifications and improving processability, a method of manufacturing an electrode through a dry process not using a solvent is getting attention, and a fiberized binder is used in the dry process.

Since the degree of fiberization of an electrode affects not only the physical properties of the electrode but also the electrochemical properties thereof, the degree of fiberization of an electrode is an important factor in designing a dry electrode. According to the degree of fiberization of the binder, the physical properties such as a tensile strength and a density of the electrode are affected, and since electron/ion conductivity paths are blocked, electrochemical properties are also controlled.

Conventionally, the degree of fiberization is confirmed by measuring a thickness and a length of a fiber through image analysis, but it is difficult to have reproducibility and representativeness because there is a limit to an analysis amount only by the image analysis. Therefore, it is necessary to quantify and standardize the degree of fiberization of the dry electrode.

### SUMMARY OF THE DISCLOSURE

The present disclosure has been made in an effort to solve the above-described problems associated with existing technologies.

A degree of fiberization of a powder for an electrode used for a dry electrode can be quantified and standardized.

In one embodiment, the present disclosure provides a powder for an electrode which satisfies a degree of fiberization suggested in the present disclosure and can be suitable for design of a high energy density electrode.

Objectives of the present disclosure are not limited to the above-described objectives. The objectives of the present disclosure will become more apparent from the following description and will be implemented by the means described in the appended claims and a combination thereof.

In an exemplary embodiment, the present disclosure provides a powder for an electrode, which includes an active material, a solid electrolyte, a conductive material, and a fibrous binder and satisfies the following Conditional Expression 1.

$$[ Conditional Expression 1 ]$$

$$2.7 \leq the degree of fiberization ( {E}_{11} / {E}_{8} ) \leq 3.6 ,$$

$$E cycle = {\int }_{0}^{H} ( \frac{T}{7.93} + F ) dH \qquad [ Equation 1 ]$$

In Conditional Expression 1, E₁₁ denotes an E_{cycle} value of an eleventh cycle calculated by Equation 1.

In Conditional Expression 1, E₈ denotes an E_{cycle} value of an eighth cycle calculated by Equation 1.

In Equation 1, T, F, and H denote a torque applied to a blade, a force applied to the blade, and a measured depth, respectively. The blade may stir the powder in a vessel at 100 rpm while descending and then ascending for the measured depth for each cycle from the first cycle to the eighth cycle. The blade may stir the powder in a vessel at a rotational speed lower than 100 rpm while descending and then ascending for the measured depth from the ninth cycle to the eleventh cycle, at which a rotational speed is 10 rpm. The blade may stir the powder in a vessel at 70 rpm at the ninth cycle and at 40 rpm at the tenth cycle while descending and then ascending for the measured depth.

The fibrous binder may include polytetrafluoroethylene (PTFE). The active material may include NCM811, the solid electrolyte may include LPSCI, and the conductive material may include VGCF.

A length of the fibrous binder may range from 4 mm to 5 mm.

A diameter of the fibrous binder may range from 0.01 μm to 20 μm.

The fibrous binder may be included in an amount ranging from 0.5 wt % to 10 wt % based on 100 wt % of the powder for an electrode.

An electrode for a secondary battery according to the present disclosure may include the powder for an electrode according to the present disclosure.

The electrode may be an electrode for a lithium ion battery or an electrode for an all-solid lithium battery.

The electrode may satisfy at least one among ion conductivity ranging from 0.20 mS to 0.50 mS, an expression dose ranging from 190 Ah/g to 193 Ah/g, a composite density ranging from 3.40 g/cc to 3.55 g/cc, and an energy density ranging from 550 mAh to 580 mAh.

A method of manufacturing a powder for an electrode according to the present disclosure may include manufacturing a mixture by dry mixing an active material, a solid electrolyte, a conductive material, and a particulate binder; mixing the mixture to manufacture a mixture mass; and pulverizing the mixture mass to manufacture a powder for an electrode.

The mixing operation may include a kneading process using a kneader.

The kneading process may be performed at a temperature ranging from 50° C. to 120° C. for 5 to 30 minutes.

The pulverizing operation may be performed using a sieve with a particle diameter ranging from 400 μm to 600 μm.

A method of manufacturing an electrode for a secondary battery according to the present disclosure may include depositing a powder for an electrode according to the present disclosure to manufacture a composite film, and forming and laminating the composite film on at least one surface of a current collector to manufacture a dry electrode.

A secondary battery according to the present disclosure may include a positive electrode manufactured according to the method of manufacturing an electrode for a secondary battery according to the present disclosure, a negative electrode, and an electrolyte interposed between the positive electrode and the negative electrode.

As discussed, the method and system suitably include use of a controller or processer.

In another embodiment, vehicles are provided that comprise an apparatus as disclosed herein.

Other embodiments and preferred embodiments of the present disclosure are discussed infra.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an instrument for measuring a degree of fiberization according to the present disclosure;

FIG. 2 shows a blade part of the instrument for measuring a degree of fiberization according to the present disclosure;

FIG. 3 shows a method of manufacturing an electrode for a secondary battery according to the present disclosure; and

FIG. 4 shows scanning electron microscope (SEM) photographs of fibrous binders of Comparative Example 1.

FIG. 5 shows scanning electron microscope (SEM) photographs of fibrous binders of Example 1.

FIG. 6 shows scanning electron microscope (SEM) photographs of fibrous binders of Example 2.

FIG. 7 shows scanning electron microscope (SEM) photographs of fibrous binders of Comparative Example 2.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The above and other objectives, features, and advantages of the present disclosure will become more apparent from the following description of exemplary embodiments with reference to the accompanying drawings. However, the present disclosure is not limited to the embodiments disclosed herein and may be implemented in other forms. Rather, the embodiments disclosed herein will be provided to make this disclosure thorough and complete, and will fully convey the spirit of the present disclosure to those skilled in the art.

In describing each drawing, similar reference numerals are assigned similar components. In the accompanying drawings, dimensions of structures are shown in an enlarged scale for clarity of the present disclosure. Although terms “first,” “second,” and the like may be used herein to describe various components, these components should not be limited to these terms. The terms are used only for the purpose of distinguishing one component from another component. For example, without departing from the scope of the present disclosure, a first component may be referred to as a second component, and similarly, a second component may also be referred to as a first component. Unless the context clearly dictates otherwise, the singular form includes the plural form.

It should be understood that the terms “comprise,” “include,” and “have” specify the presence of stated herein features, numbers, steps, operations, components, elements, or combinations thereof, but do not preclude the presence or possibility of adding one or more other features, numbers, steps, operations, components, elements, or combinations thereof. In addition, when a portion of a layer, a film, a region, a plate, or the like is referred to as being “on” other portion, this includes not only a case in which the portion is “directly on” the other portion but also a case in which another portion is present between the portion and the other portion. Conversely, when a portion of a layer, a film, a region, a plate, or the like is referred to as being “under” other portion, this includes not only a case in which the portion is “directly under” the other portion but also a case in which another portion is present between the portion and the other portion.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, when a numerical range is disclosed herein, such a numerical range is continuous and, unless otherwise indicated, the numerical range includes all values from a minimum value to a maximum value. Further, when the numerical range refers to integers, unless otherwise indicated, all integers from a minimum value to a maximum value are included.

A powder for an electrode may include an active material, a solid electrolyte, a conductive material, and a fibrous binder.

The electrode may be a positive electrode, and the active material may be a positive electrode active material.

The positive electrode active material is not limited as long as it is in the form of lithium transition metal oxide, lithium metal iron phosphorus oxide, or metal oxide and may include, for example, layered compounds such as lithium cobalt oxide (LiCoO₂) and lithium nickel oxide (LiNiO₂) or compounds substituted with one or more transition metals; lithium manganese oxides such as LiMnO₃, LiMn₂O₃, and LiMnO₂, which are expressed by chemical formula Li₁₊ₓMn₂₋ₓO₄ (here x ranges from zero to 0.33); lithium copper oxide (Li₂CuO₂); vanadium oxides such as LiV₃O₈, LiFe₃O₄, V₂O₅, and Cu₂V₂O₇; Ni site type lithium nickel oxide expressed by chemical formula LiNi₁₋ₓMₓO₂ (here M=Co, Mn, Al, Cu, Fe, Mg, B or Ga, and x=0.01 to 0.3); lithium manganese composite oxide expressed by chemical formula LiMn₂₋ₓMxO₂ (here M=Co, Ni, Fe, Cr, Zn or Ta and x=0.01 to 0.1) or Li₂Mn₃MO₈ (here M =Fe, Co, Ni, Cu, or Zn); LiMn₂O₄ in which a Li part of the chemical formula is replaced with an alkaline earth metal ion; lithium metal phosphorus oxide LiMPO₄ (here M=Fe, CO, Ni, or Mn); disulfide compounds; and Fez (MoO₄)₃, but the present disclosure is not limited thereto.

The electrode may be a negative electrode, and the active material may be a negative electrode active material.

Carbon such as non-graphitized carbon or graphitized carbon; metal composite oxide such as LiₓFe₂O₃ (0≤x≤1), LiₓWO₂ (0≤x≤1), or SnₓMe₁₋ₓMe′yO_{z} (Me is Mn, Fe, Pb, or Ge, Me′ is Al, B, P, or Si, group 1, 2, 3 elements of the periodic table, halogens, 0<x≤1, 1≤y≤3, and 1≤z≤8); lithium metal; a lithium alloy; a silicon-based alloy; a tin-based alloy; silicon-based oxides such as SiO, SiO/C, and SiO2; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; a conductive polymer such as polyacetylene; or a Li—Co—Ni based material may be used as the negative electrode active material.

The electrode may preferably be a positive electrode, and the active material may be a positive electrode active material, and more specifically, may be lithium nickel-manganese-cobalt-based oxide (LiNi_{0.8}Co_{0.1}Mn_{0.1}O₂; NCM811).

The solid electrolyte may be a sulfide-based solid electrolyte or an oxide-based solid electrolyte as a component responsible for lithium ion conduction of an electrode including the same.

The solid electrolyte may be a solid electrolyte according to the following Chemical Formula 1.

[Chemical Formula 1]

LₐM_{b}P_{c}S_{d}Xₑ

(In Chemical Formula 1, L is one or more elements selected from the group consisting of alkali metals, M is one or more elements selected from the group consisting of B, Al, Ga, In, Si, Ge, Sn, Pb, As, Sb, Bi, Ti, V, Mn, Fe, Co, Ni, Cu, Y, Zr, Nb, Mo, Tc, Ru, Rh, Pd, Ag, Hf, Ta, and W, X is one element selected from the group consisting of F, Cl, Br, I and O, 0≤a ≤12, 0≤b≤6,0≤c≤6,0≤12, and 0≤e ≤9.)

For example, the solid electrolyte may include one or more selected from the group consisting of Li₆PS₅Cl, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂SP₂S₅—Li₂O—LiI, Li₂S—SiS₂, LizS—SiS₂—LiI, Li₂S—SiS₂—LiBr, Li₂S—SiS₂—LiCI, Li₂S—SiS₂—B₂S₃—LiI, Li₂S—SiS₂—P₂S₅—LiI, Li₂S—B₂S₃, Li₂S—P₂S₅—ZmSn (m and n are positive numbers and Z is one of Ge, Zn, and Ga), Li₂S—GeS₂, Li₂S—SiS₂—Li₃PO₄, Li₂S—SiS₂—LiₓMO_{y} (x and y are positive numbers and M is one of P, Si, Ge, B, Al, Ga, and In), and LiGeP₂S₁₂.

The conductive material is not particularly limited as long as it has electrical conductivity without causing a chemical change in a battery. For example, the conductive material may include graphite including natural graphite and artificial graphite; carbon-based materials including carbon black, acetylene black, ketjen black, channel black, furnace black, lamp black, and summer black; conductive fibers including a carbon fiber and a metal fiber; metal powders including a carbon fluoride powder, an aluminum powder, and a nickel powder; conductive whiskeys including zinc oxide and potassium titanate; a conductive metal oxide including titanium oxide; and a conductive material including a polyphenylene derivative. Specifically, for uniform mixing of the conductive material and improvement of conductivity, one or more selected from the group consisting of activated carbon, graphite, carbon black, and carbon nanotube may be included, and more specifically, activated carbon may be included.

The conductive material may preferably be a vapor grown carbon fiber (VGCF).

The fibrous binder may include PTFE.

A length of the fibrous binder may range from about 4 mm to about 5 mm.

A diameter of the fibrous binder may range from about 0.01 μm to about 20 μm.

The fibrous binder may be included in an amount ranging from about 0.5 wt % to about wt % based on 100 wt % of the powder for an electrode.

When a content of the binder is too small out of the above range, formability is poor, and thus there is a disadvantage in that it is difficult to manufacture a uniform clay type electrode, and when the content of the binder is too large, denier is not controlled and rather the binder agglomerates, and thus there is a disadvantage of increasing resistance of the electrode.

Recently, for developing high energy density battery specifications and improving processability, a method of manufacturing an electrode through a dry process not using a solvent is getting attention, and a fibrous binder is used in the dry process.

Since the degree of fiberization of an electrode affects not only the physical properties of the electrode but also the electrochemical properties thereof, the degree of fiberization of an electrode is an important factor in designing a dry electrode. According to the degree of fiberization, the physical properties such as a tensile strength and a density of the electrode are affected, and electron/ion conductivity paths are blocked, and thus electrochemical properties are also controlled.

Conventionally, the degree of fiberization is confirmed by measuring a thickness and a length of a fiber through image analysis, but it is difficult to have reproducibility and representativeness because there is a limit to an analysis amount only by the image analysis. Therefore, it is necessary to quantify and standardize the degree of fiberization of the electrode.

The present disclosure relates to an electrode including fiberized PTFE as a binder. The PTFE is a polymer in which all hydrogens of PE are substituted with fluorine, and although PTFE is a polymer having an aliphatic main chain, PTFE has excellent thermal stability and electrical stability and is widely used in electronic material applications. In particular, a highest occupied molecular orbital (HOMO) level of the polymer is low and oxidation stability is high, and thus PTFE is applied to the positive electrode dry electrode. A vitrification temperature (T_{g}) of PTFE is about 120° C., but since a temperature of beta transition is lower than room temperature, PTFE has a fiberization characteristic when a pressure is applied.

PTFE may control a thickness and a length of a fiber through a kneading process, and the more fiberization occurs, the better the binding ability of an electrode powder so that electrode desorption may less occur during charging/discharging. However, since electron/ionic conductivity paths are blocked, electrochemical properties vary and a composite density is also decreased so that it is important to control the degree of fiberization of PTFE in the electrode.

Conventionally, the degree of fiberization is confirmed by measuring a thickness and a length of a fiber through image analysis, but it is difficult to have reproducibility and representativeness because there is a limit to an analysis amount only by the image analysis. Therefore, it is necessary to quantify and standardize the degree of fiberization of the electrode.

Thus, the present disclosure proposes a method of standardizing a degree of fiberization and shows that a powder for an electrode having a degree of fiberization between about 2.7 and about 3.6 can be implemented as a high energy density electrode.

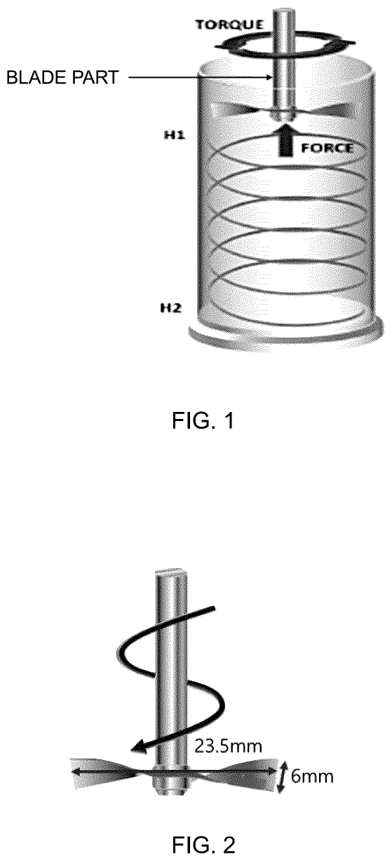

FIG. 1 shows an instrument for measuring a degree of fiberization according to the present disclosure. Referring to FIG. 1, the powder may satisfy the following Conditional Expression 1.

$$2.7 \leq degree of fiberization ( {E}_{11} / {E}_{8} ) \leq 3.6 \qquad [ Conditional Expression 1 ]$$

$$E cycle = {\int }_{0}^{H} ( \frac{T}{7.93} + F ) dH \qquad [ Equation 1 ]$$

In Conditional Expression 1, E₁₁ denotes an E_{cycle} value of an eleventh cycle calculated by Equation 1.

In Conditional Expression 1, E₈ denotes an E_{cycle} value of an eighth cycle calculated by Equation 1.

In Equation 1, T, F, and H denote a torque, a force, and a measured depth, respectively.

T, F and H in Equation 1 are obtained by a measuring instrument including a cylindrical body part, and a blade part mounted on the body part to rotate and configured to ascend and descend.

FIG. 2 shows a blade part of the instrument for measuring a degree of fiberization according to the present disclosure. Referring to FIG. 2, the blade part includes a blade mounted and tilted at an angle of about 5°, and a column connected to the blade, wherein the blade has a length of about 23.5 mm and a width of about 6 mm. The length denotes a size in a horizontal direction, and the width denotes a size in a vertical direction.

T in E₁₁ means a torque applied to the blade when the blade descends at a rotational speed of 10 rpm, F means a force applied to the blade when the blade descends at the rotational speed of 10 rpm, and H is a measured depth and means a distance from H1 (a point about 2 mm apart from the top of the body part) to H2 (a point about 55 mm apart from the top of the body part).

T in E₈ means a torque applied to the blade when the blade descends at a rotational speed of about 100 rpm, F means a force applied to the blade when the blade descends at the rotational speed of about 100 rpm, and H is a measured depth and means a distance from H1 (the point about 2 mm apart from the top of the body part) to H2 (the point about 55 mm apart from the top of the body part).

One cycle means movement when the blade part moves from H1 at the top of the blade part to H2 at the bottom of the blade part and then moves to H1 at the top of the blade part again.

The degree of fiberization may be measured by the following method.

First, the powder for an electrode is put in a about 25 mm×about 25 mL split vessel. In this case, an amount of the powder for an electrode should fill the about 25 mL vessel.

Then, the blade part is stirred under the following conditions. In this case, the blade part moves downward to a floor and then moves upward while rotating, and this movement is referred to as one cycle. (speed during one to eighth cycles: about 100 rpm, speed during ninth cycle: about 70 rpm, speed during tenth cycle: about 40 rpm, speed during eleventh cycle: about 10 rpm)

Finally, the degree of fiberization is calculated according to Conditional Expression 1.

An electrode for a secondary battery according to the present disclosure may include the above-described powder for an electrode.

The electrode may be an electrode for a lithium ion battery or an electrode for an all-solid lithium battery.

Ion conductivity of the electrode may range from about 0.20 mS to about 0.50 mS.

An expression dose of the electrode may range from about 190 mAh/g to about 193 mAh/g.

A composite density of the electrode may range about 3.40 g/cc to about 3.55 g/cc.

An energy density of the electrode may range from about 550 mAh to about 580 mAh.

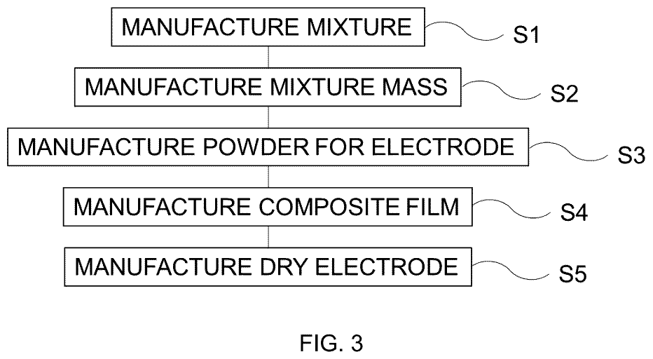

FIG. 3 shows a method of manufacturing a powder for an electrode and an electrode for a secondary battery according to the present disclosure. Referring to FIG. 3, the method may include manufacturing a mixture by dry mixing an active material, a solid electrolyte, a conductive material, and a particulate binder (S1); mixing the mixture to manufacture a mixture mass (S2); and pulverizing the mixture mass to manufacture the powder for an electrode (S3).

Manufacturing of mixture by dry mixing active material, solid electrolyte, conductive material, and particulate binder (S1)

Operation S1 is an operation of manufacturing a mixture by putting an active material, a solid electrolyte, a conductive material, and a particulate binder, which are materials necessary for manufacturing an electrode for a secondary battery and then mixing the active material, the solid electrolyte, the conductive material, and the particulate binder to be uniformly dispersed.

The active material, the solid electrolyte, the conductive material, and the particulate binder are the same as those described above, and thus descriptions thereof will be omitted.

The mixing is performed in a dry manner without using a solvent so that an effect of improving processability can be obtained.

The mixing is not limited to a typical physical mixing process that can be used in the present disclosure, but may be performed using, for example, a high-speed/high-shear mixer.

The rpm and time during the mixing process may vary according to a manufacturing environment.

### Mixing of Mixture to Manufacture Mixture Mass (S2)

Operation S2 is an operation of mixing the mixture to fiberize a particulate binder and kneading the particulate binder into a mixture mass.

The kneading process is a process that can satisfy the above characteristics, and conventionally, high shear mixing as in a jet-mill is performed to fiberize the binder, and there occurs a problem in that an active material is pulverized by the mixing, and the formed fibers may be cut. In the present application, the problem is solved by a low-shear mixing method instead of a high-shear mixing method.

The kneading is not limited to a typical physical mixing process that can be used in the present disclosure, but may be performed as a kneading process through a kneading machine, for example, a kneader.

Through the kneading process, since the binder is fiberized and the active material, the solid electrolyte, and the conductive materials are combined or connected, a mixture mass with a solid content of 100% may be formed.

The kneading may be performed at a temperature ranging from about 50° C. to about 120° C. for 5 to 30 minutes.

When a time of the kneading is too short or the temperature is low out of the above ranges, there is a disadvantage in that agglomeration due to the fiberization and mixing of the binder is not well achieved, whereas, when the time of the kneading time is too long or the temperature is high, excessive fiberization of the binder may occur, and thus performance of the electrode may be deteriorated. When the excessive fiberization of the binder occurs, the composite density of the electrode may be reduced and, simultaneously, the energy density may also be reduced. In addition, since the binder hinders paths of lithium ions, ion conductivity is also reduced.

The time and temperature during the kneading process may vary according to the manufacturing environment.

### Pulverizing of Mixture Mass to Manufacture Powder for Electrode (S3)

Operation S3 is an operation of pulverizing the mixture mass obtained in operation S2 again to manufacture a uniformly dispersed powder for an electrode and may be a final preparation operation of manufacturing a sheet-shaped electrode.

Specifically, the mixture mass manufactured through operation S2 is kneaded and a shape of the mixture mass is changed into one large mass. When the mixture mass is directly pressed under a strong pressure and a high temperature to form a thin film, there may occur a problem in that the density of the film may be too high or a uniform film cannot be obtained. In order to obtain powder for an electrode in the form of a uniform powder even for fiberization measurement, the pulverizing of operation S3 is required.

The pulverizing Is not limited to a conventional pulverizing process that can be used in the present disclosure, but may be performed through a pulverizer, for example, a pin mill.

The pulverizing may be performed using a sieve with a particle diameter ranging from 400 μm to 600 μm. In this way, a uniformly dispersed powder may be obtained.

The degree of fiberization in Conditional Expression 1 is a measured degree of fiberization of the powder for an electrode which is the result of the corresponding operation. The degree of fiberization increases when the kneading of operation S2 is performed, and when the pulverizing process of operation S3 is performed, the degree of fiberization is decreased as fibers are broken. However, when a deposition/lamination process of the electrode manufacturing operation is performed after operation S3, the degree of fiberization is restored because the fibers are reattached.

The rpm and time during the pulverizing process may vary according to a manufacturing environment.

A method of manufacturing an electrode for a secondary battery according to the present disclosure may include depositing the above-manufactured powder for an electrode to manufacture a composite film (S4), and forming and laminating the composite film on at least one surface of a current collector to manufacture a dry electrode (S5).

### Depositing of Powder for Electrode to Manufacture Composite Film (S4)

Operation S4 is a preparation operation of manufacturing a dry electrode by depositing the powder for an electrode and processing the powder in the form of a film.

The film may have an average thickness ranging from about 50 μm to about 300 μm.

The deposition is not limited to a conventional deposition process usable in the present disclosure, but the deposition may be performed, for example, through a roll press. In this case, a temperature, a pressure, a gap between rolls, and a roll speed may vary according to the manufacturing environment.

Since the composite film manufactured as described above does not include a solvent, the composite film has almost no fluidity and thus is easy to handle and is processed into a desired shape, thereby being used for manufacturing various types of electrodes. In addition, when the electrode composite of the present disclosure is used for the electrode manufacturing, since the drying process for solvent removal may be omitted, it is possible to significantly improve manufacturing processability of the electrode and to solve problems such as a fine powder of the active material or disconnection of the fiberized binder, which are problems in the manufacturing of the existing dry electrode.

### Forming and Laminating of Composite Film on at Least One Surface of Current Collector to Manufacture Dry Electrode (S5)

Operation S5 is an operation of manufacturing a dry electrode by forming and laminating a film on at least one surface of a current collector.

The lamination may be an operation of rolling and attaching the film on the current collector at a predetermined thickness.

The lamination is not limited to a conventional lamination process usable in the present disclosure, but the lamination may be performed, for example, through a roll press. In this case, a temperature, a pressure, a gap between rolls, and a roll speed may vary according to the manufacturing environment.

The composite film on the dry electrode, which is manufactured as described above, may have porosity in an appropriate range.

The secondary battery according to the present disclosure may include the positive electrode manufactured as described above, a negative electrode, and an electrolyte interposed between the positive electrode and the negative electrode.

Hereinafter, the present disclosure will be described in detail with reference to the following Examples and Comparative Examples. However, the technical spirit of the present disclosure is not restricted or limited thereto.

### EXAMPLES 1 AND 2 AND COMPARATIVE EXAMPLES 1 AND 2

### Example 1

S1. An active material (NCM811), a solid electrolyte (LPSCI), a conductive material (VGCF), and a binder (PTFE) are mixed without a solvent to manufacture a mixture.

S2. Shear stress is applied to the mixture, and kneading is performed at a temperature of about 80° C. for about 5 minutes to fiberize PTFE. In this case, the mixture is agglomerated to manufacture a mixture mass in the form of clay.

S3. The mixture mass is pulverized using pin mill equipment to manufacture a powder for an electrode, which is a uniformly dispersed powder composite of about 500 μm or less.

### Example 2

A powder for an electrode was prepared in the same manner as in Example 1, except that a time of the kneading in operation S2 of Example 1 was about 30 minutes.

### Comparative Example 1

A powder for an electrode was prepared in the same manner as in Example 1, except that a time of the kneading in operation S2 of Example 1 was zero minute (operation S2 is not performed).

### Comparative Example 2

A powder for an electrode was prepared in the same manner as in Example 1, except that a time of the kneading in operation S2 of Example 1 was 6 minutes.

### Test Example 1: Comparison of Length and Diameter of Fibrous Binder According to Degree of Fiberization

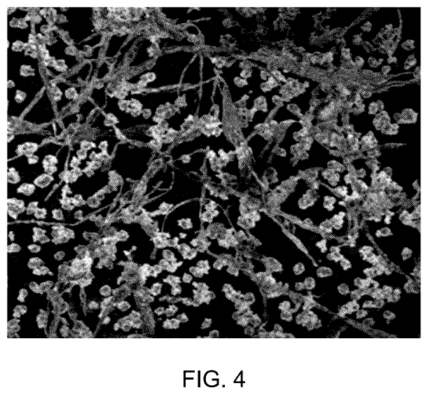

Tests were performed to measure the degree of fiberization of the powders for an electrode manufactured in Examples 1 and 2 and Comparative Examples 1 and 2 and to measure scanning electron microscope (SEM), a fiber length, and a diameter of PTFE that was the binder. The results are shown in Table 1 and FIG. 4 to FIG. 7.

### [Method of Measuring Degree of Fiberization]

1. The powder for an electrode is put in a about 25 mm×about 25 mL split vessel. In this case, an amount of the powder for an electrode should fill the about 25 mL vessel.

2. The blade part is stirred under the following conditions.

In this case, the blade part moves downward to a floor and then moves upward while rotating, and this movement is referred to as one cycle.
Speed during first to eighth cycles: about 100 rpm
Speed during ninth cycle: about 70 rpm
Speed during tenth cycle: about 40 rpm
Speed during eleventh cycle: about 10 rpm

3. The degree of fiberization is calculated according to Conditional Expression 1.

$$2.7 \leq degree of fiberization ( {E}_{11} / {E}_{8} ) \leq 3.6 \qquad [ Conditional Expression 1 ]$$

$$E cycle = {\int }_{0}^{H} ( \frac{T}{7.93} + F ) dH \qquad [ Equation 1 ]$$

In Conditional Expression 1, E₁₁ denotes an E_{cycle} value of an eleventh cycle, and the E_{cycle} value is a value calculated by Equation 1.

In Conditional Expression 1, E₈ denotes an E_{cycle} value of an eighth cycle, and the E_{cycle} value is a value calculated by Equation 1.

T, F and H in Equation 1 are obtained by a measuring instrument including a cylindrical body part, and a blade part mounted on the body part to rotate and configured to ascend and descend.

The blade part includes a blade mounted and tilted at an angle of about 5°, and a column connected to the blade, wherein the blade has a length of about 23.5 mm and a width of about 6 mm.

T in E₁₁ means a torque applied to the blade when the blade descends at a rotational speed of about 10 rpm, F means a force applied to the blade when the blade descends at the rotational speed of about 10 rpm, and H is a measured depth and means a distance from H1 (the point 2 mm apart from the top of the body part) to H2 (the point 55 mm apart from the top of the body part).

T in E₈ means a torque applied to the blade when the blade descends at a rotational speed of about 100 rpm, F means a force applied to the blade when the blade descends at the rotational speed of about 100 rpm, and H is a measured depth and means a distance from H1 (the point 2 mm apart from the top of the body part) to H2 (the point 55 mm apart from the top of the body part).

TABLE 1

| | | | Comparative | Comparative |
|---|---|---|---|---|
| Items | Example 1 | Example 2 | Example 1 | Example 2 |
| Time of kneading | 5 | 30 | 0 | 60 |
| (minutes) | | | | |
| Degree of | 2.7 | 3.6 | 2 | 4.5 |
| fiberization | | | | |
| Fiber length (mm) | 4 | 5 | 1 | 5.6 |
| Fiber diameter (μm) | 3 | 4.5 | 2 | 8 |

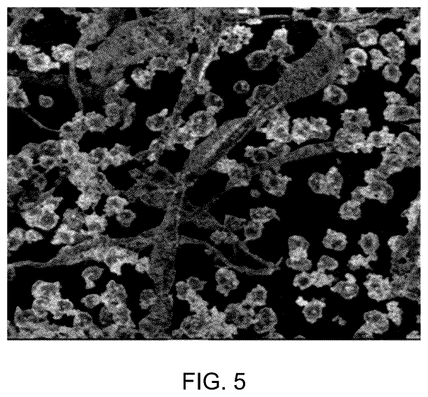

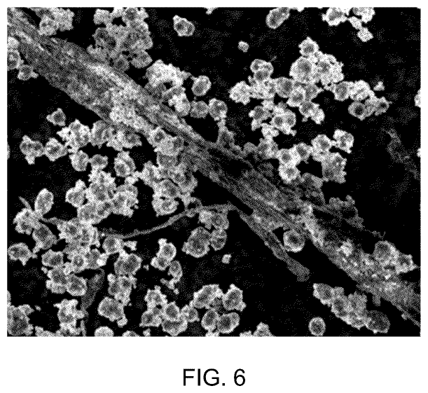

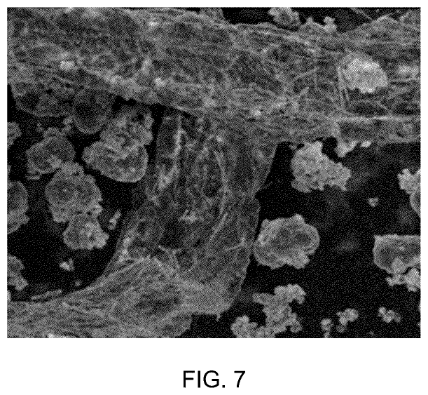

FIG. 4 shows SEM image of fibrous binders of Comparative Example 1. FIG. 5 shows SEM image of fibrous binders of Example 1. FIG. 6 shows SEM image of fibrous binders of Example 2. FIG. 7 shows SEM image of fibrous binders of Comparative Example 2.

Examples and Comparative Examples according to the present disclosure. Referring to FIG. 4 to FIG. 7, it can be seen that the longer the time of the kneading, the higher the degree of fiberization value and the higher the fiber length and diameter. In addition, in Comparative Example 1 without the kneading, only mixing was performed, and it can be seen that only slight fiberization of the binder was performed.

### Test Example 2: Comparison of Electrochemical Properties and Composite Density According to Degree of Fiberization

The electrode for a secondary battery was manufactured using the powders for an electrode manufactured in Examples and Comparative Examples, and a test was conducted to measure electrochemical properties and composite densities of the electrode. The results are shown in the following Table 2.

### [Method of Manufacturing an Electrode for a Secondary Battery]

S4: The powder was put into a roll press (a roll diameter: about 100 mm, a roll temperature: about 80° C., and about 5 rpm) to manufacture a composite film.

S5: An electrode was manufactured by placing the composite film on one side of aluminum foil (about 15 μm) and laminating the composite film through a lamination roll maintained at a temperature of about 100° C.

TABLE 2

| | | | Comparative | Comparative |
|---|---|---|---|---|
| Items | Example 1 | Example 2 | Example 1 | Example 2 |
| Degree of | 2.7 | 3.6 | 2 | 4.5 |
| fiberization | | | | |
| Ion conductivity | 0.44 | 0.30 | 0.52 | 0.18 |
| (mS) | | | | |
| Expression dose | 190 | 193 | 180 | 185 |
| (mAh/g) | | | | |
| Composite density | 3.53 | 3.45 | 3.58 | 3.32 |
| (g/cc) | | | | |
| Energy density | 570 | 565 | 520 | 540 |
| (mAh) | | | | |

Referring to Table 2, it can be seen that the energy density is proportional to the expression dose and inversely proportional to the composite density.

The higher the ion conductivity, the better the expression dose, but even though the ion conductivity is high, when the powder for an electrode is desorbed, the expression dose, which is the result of the overall electrochemical characteristics and physical properties, decreases.

In addition, it can be confirmed that, as the degree of fiberization increases, paths of lithium ions are hindered, and thus the ionic conductivity decreases, and cohesiveness of the powder for an electrode is improves so that an effect as the binder increases and the composite density is decreased.

That is, in order to design an electrode with a high energy density, it can be confirmed that the powder for an electrode with the degree of fiberization of about 2.7 or more and about 3.6 or less as defined in the present disclosure is appropriate.

In accordance with the present disclosure, by standardizing a degree of fiberization, it is possible to design a degree of fiberization of a dry electrode without using a solvent so that an electrode with a high energy density can be implemented.

The effects of the present disclosure are not limited to the above-described effects. It should be understood that the effects of the present disclosure include all effects which can be inferred from the above description.

While the embodiments of the present disclosure have been described, those skilled in the art can understand that the present disclosure can be implemented in other specific forms without departing from the technical spirit or the necessary features of the present disclosure. Therefore, it should be understood that the above-described embodiments are not restrictive but illustrative in all embodiments.

What is claimed is:

1. A powder for an electrode, comprising:
an active material;
a solid electrolyte;
a conductive material; and
a fibrous binder,
wherein a degree of fiberization of the powder satisfies the following Conditional Expression 1:
$$2.7 \leq the degree of fiberization ( = {E}_{11} / {E}_{8} ) \leq 3.6 , \qquad [ Conditional Expression 1 ]$$
$$E cycle = {\int }_{0}^{H} ( \frac{T}{7.93} + F ) dH , \qquad [ Equation 1 ]$$
wherein in the Conditional Expression 1, E₁₁ denotes an E_{cycle} value of an eleventh cycle calculated by Equation 1,
wherein in the Conditional Expression 1, E₈ denotes an E_{cycle} value of an eighth cycle calculated by Equation 1, and
wherein in the Equation 1, T, F, and H denote a torque applied to a blade, a force applied to the blade, and a measured depth, respectively.

2. The powder of claim 1, wherein the fibrous binder comprises polytetrafluoroethylene (PTFE).

3. The powder of claim 1, wherein the active material comprises NCM811, the solid electrolyte comprises LPSCI, and the conductive material comprises VGCF.

4. The powder of claim 1, wherein a length of the fibrous binder ranges from about 4 mm to about 5 mm, or a diameter of the fibrous binder ranges from about 0.01 μm to about 20 μm.

5. The powder of claim 1, wherein the fibrous binder is comprised in an amount ranging from about 0.5 wt % to about 10 wt % based on 100 wt % of the powder for an electrode.

6. The powder of claim 1, wherein the blade stirs the powder in a vessel at 100 rpm while descending and then ascending for the measured depth for each cycle from the first cycle to the eighth cycle, and wherein the blade stirs the powder in a vessel at 70 rpm at the ninth cycle, at 40 rpm at the tenth cycle, and at 10 rpm at the eleventh cycle while descending and then ascending for the measured depth.

7. An electrode for a secondary battery comprising the powder of claim 1.

8. The electrode of claim 7, wherein the electrode is an electrode for a lithium ion battery or an electrode for an all-solid lithium battery.

9. The electrode of claim 7, wherein the electrode for the secondary battery satisfies at least one among ion conductivity ranging from about 0.20 mS to about 0.50 mS, an expression dose ranging from about 190 mAh/g to about 193 mAh/g, a composite density ranging from about 3.40 g/cc to about 3.55 g/cc, and an energy density ranging from about 550 mAh to about 580 mAh.

10. A secondary battery, comprising:
a positive electrode manufactured according to the method of claim 1;
a negative electrode; and
an electrolyte interposed between the positive electrode and the negative electrode.

11. A method of manufacturing a powder for an electrode, the method comprising:
manufacturing a mixture by dry mixing an active material, a solid electrolyte, a conductive material, and a particulate binder;
mixing the mixture to manufacture a mixture mass; and
pulverizing the mixture mass to manufacture the powder for an electrode,
wherein a degree of fiberization of the powder for the electrode satisfies the following Conditional Expression 1:
$$2.7 \leq the degree of fiberization ( = {E}_{11} / {E}_{8} ) \leq 3.6 , \qquad [ Conditional Expression 1 ]$$
$$E cycle = {\int }_{0}^{H} ( \frac{T}{7.93} + F ) dH , \qquad [ Equation 1 ]$$
wherein in the Conditional Expression 1, E₁₁ denotes an E_{cycle} value of an eleventh cycle calculated by Equation 1,
wherein in the Conditional Expression 1, E₈ denotes an E_{cycle} value of an eighth cycle calculated by Equation 1,
wherein in the Equation 1, T, F, and H denote a torque applied to a blade, a force applied to the blade, and a measured depth, respectively,
wherein the blade stirs the powder in a vessel at 100 rpm while descending and then ascending for the measured depth for each cycle from the first cycle to the eighth cycle, and
wherein the blade stirs the powder in a vessel at a rotational speed lower than 100 rpm while descending and then ascending for the measured depth from the ninth cycle to the eleventh cycle, at which a rotational speed is 10 rpm.

12. The method of claim 11, wherein the binder comprises polytetrafluoroethylene (PTFE).

13. The powder of claim 11, wherein the active material comprises NCM811, the solid electrolyte comprises LPSCI, and the conductive material comprises VGCF.

14. The method of claim 11, wherein a length of the binder ranges from about 4 mm to about 5 mm, or a diameter of the binder ranges from about 0.01 μm to about 20 μm.

15. The method of claim 11, wherein the mixing comprises a kneading process using a kneader.

16. The method of claim 17, wherein the kneading process is performed at a temperature ranging from about 50° C. to about 120° C. for about 5 to about 30 minutes.

17. The method of claim 11, wherein the pulverizing is performed using a sieve with a particle diameter ranging from about 400 μm to about 600 μm.

18. The method of claim 11, wherein the binder is comprised in an amount ranging from about 0.5 wt % to about 10 wt % based on 100 wt % of the powder for an electrode.

19. A method of manufacturing an electrode for a secondary battery, the method comprising:
depositing the powder for the electrode of claim 1 to manufacture a composite film; and
forming and laminating the composite film on at least one surface of a current collector to manufacture a dry electrode.

20. The method of claim 18, wherein the electrode for the secondary battery satisfies at least one among ion conductivity ranging from about 0.20 mS to about 0.50 mS, an expression dose ranging from about 190 mAh/g to about 193 mAh/g, a composite density ranging from about 3.40 g/cc to about 3.55 g/cc, and an energy density ranging from about 550 mAh to about 580 mAh.
